(19) United States
(12) Patent Application Publication
(10) Pub. No.: US 2014/0327526 A1
(43) Pub. Date: Nov. 6, 2014

(54) CONTROL SIGNAL BASED ON A COMMAND TAPPED BY A USER

(71) Applicants: Charles Edgar Bess, Frisco, TX (US); Abhay Mehta, Austin, TX (US); Henri J. Suermondt, Sunnyvale, CA (US)

(72) Inventors: Charles Edgar Bess, Frisco, TX (US); Abhay Mehta, Austin, TX (US); Henri J. Suermondt, Sunnyvale, CA (US)

(21) Appl. No.: 14/372,296

(22) PCT Filed: Apr. 30, 2012
(86) PCT No.: PCT/US12/35777

§ 371 Date: Jul. 15, 2014

(51) Int. Cl. G08C 17/02

(52) U.S. Cl. CPC G08C 17/02
USPC 340/12.52

(57) ABSTRACT

A system includes at least three accelerometers disposed in different locations of an area with a surface to capture respective vibration data corresponding to a command tapped onto the surface by a user and a processing system to receive the vibration data from each accelerometer, identify the command and a location of the user from the vibration data, and generate a control signal based on the command and the location.

### BACKGROUND

Users of devices often seek new ways of controlling the operation of the devices. Methods to control a device generally involve the physical interaction of a user with either the device itself or a control device (e.g., a remote control) that controls the device of interest. Although some control devices may be used to control more than one other device, a user typically possesses the control device in order to operate it and control other devices. In addition, previous control devices may not have the capability to consider the location of the user in determining how to control a device.

### BRIEF DESCRIPTION OF THE DRAWINGS

FIG. 1 is a schematic diagram illustrating one embodiment of a system for controlling devices based on commands tapped by a user.

FIG. 2 is a flow chart illustrating one embodiment of a method for controlling devices based on commands tapped by a user.

FIG. 3 is a flow chart illustrating one embodiment of a method for processing vibration data to identify a command tapped by a user and a location of the user.

FIG. 4 is a flow chart illustrating one embodiment of a method for controlling devices based on commands tapped by a user and a location of the user.

FIG. 5 is a block diagram illustrating one embodiment of a system for controlling devices based on commands tapped by a user.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As described herein, a system detects commands tapped from a user and controls devices based on the commands and the location of the user. The system includes at least three accelerometers disposed in an area with a surface that capture respective vibration data corresponding to a command tapped onto the surface by the user. The accelerometers each provide the captured vibration data to a processing system that identifies the command and a location of the user from the vibration data (e.g., by triangulation). The processing system generates a control signal based on the command and the location and provides the control signal to a device to perform a function associated with the command.

By analyzing the vibration data, the processing system controls predefined devices in the area without the use of hand held or other control apparatus by the user. The user simply provides a series of taps corresponding to a predefined command for a device onto any suitable solid surface in an area. The vibrations of the taps transmit through from the tapping surface to the accelerometers through any solid structures between the tap surface and the accelerometers (e.g., floors, walls, ceilings, or other structures in the area). The accelerometers capture the vibrations of the taps in the vibration data. The accelerometers form a data network that enables the processing system to correlate and analyze the vibration data from the accelerometers in a coordinated manner. The processing system discerns the function to be performed and the device on which the function is to be performed using the detected series of taps in the vibration data and the location of the user determined by triangulation of vibration data from different accelerometers. Accordingly, the system described herein may be used to turn on lights, adjust the temperature, or notify authorities that someone has fallen and cannot get up, cannot reach a nurse call button, or is blocked from reaching a location, for example.

As used herein, the term device refers to any suitable apparatus that performs functions that are controllable in response to a signal from a processing system. In addition, the term vibration data refers to a set of data values that collectively represent the frequency and amplitude of the vibrations detected by an accelerometer over time. In addition, the term command refers to predefined series of taps that a user imparts to a surface in an area.

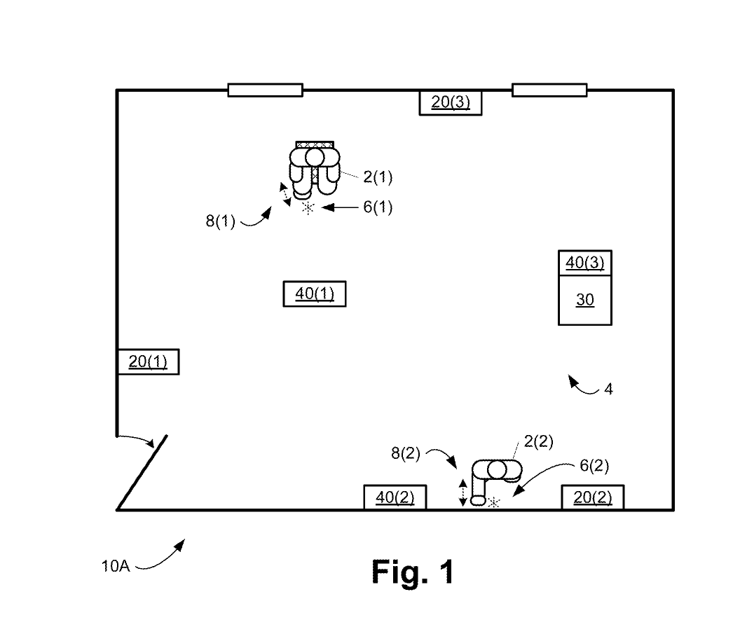

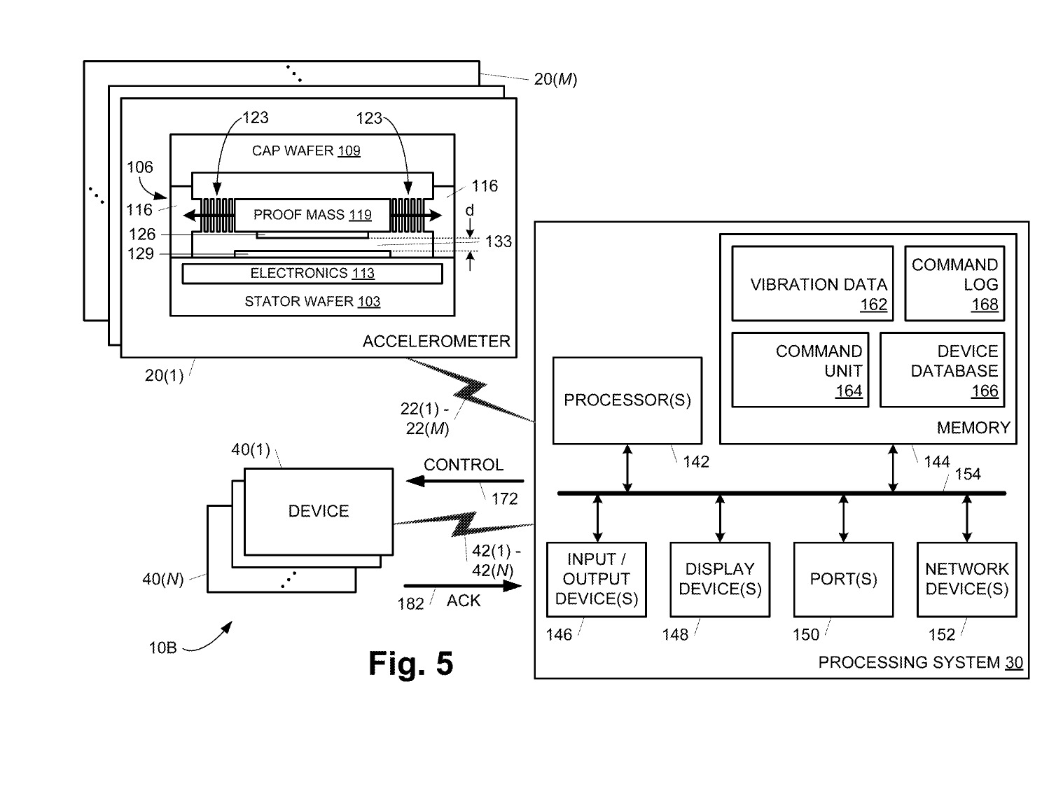

FIG. 1 is a schematic diagram illustrating one embodiment 10A of a system 10 for controlling devices 40 based on commands tapped by users 2 on surfaces 6 in an area 4 as indicated by dotted arrows 8. System 10 includes at least three accelerometers 20 (e.g., accelerometers 20(1), 20(2), and 20(3) as shown in the example of FIG. 1) disposed in different locations of area 4. Each accelerometer 20 captures vibration data (shown collectively as vibration data 162 in the embodiment of FIG. 5) from vibrations present in area 4 and provides the vibration data to a processing system 30. The vibration data includes vibrations that represent commands tapped by users 2 to control devices 40 (i.e., cause functions to be performed by devices 40). Processing system 30 identifies commands from users 2 in the vibration data, identifies the locations of users 2 using triangulation of the vibration data, and generates control signals based on the commands and locations of users 2. Processing system 30 provides the control signals to devices 40 to cause functions to be performed in accordance with the commands from users 2.

Users 2 may tap commands on any suitable solid surface 6 in area 4 to cause vibrations to transmit to accelerometers 20. Area 4 represents any suitable physical space that includes users 2, surfaces 6, and accelerometers 20 and possibly processing system 30 and one or more devices 40. For example, area 4 may represent one or more rooms inside a home (e.g., a house, condominium, town house, or apartment), an office, a place of business, or a location in a healthcare facility. Surfaces 6 may include structural components of the space of area 4, such as floors, walls, ceilings, windows, and doors, and other structures, objects, and apparatus present in area 4.

Accelerometers 20 are disposed in area 4 with a physical connection to one or more solid surfaces 6 to allow vibrations to transmit from the surfaces 6 tapped by users 2 to the surfaces 6 in physical contact with accelerometers 20. The vibrations transmit though any solid materials of area 4 between the tapped surfaces 6 and the surfaces in physical contact with accelerometers 20. In some embodiments, accelerometers 20 may be disposed on a foundation or other major structural components of a home or building to provide a continuous solid material contact with as many surfaces 6 in area 4 as possible.

Accelerometers 20 are disposed in different locations of area 4 to allow processing system 30 to triangulate a location of a user 2. For example, accelerometers 20 may be placed at corners of a room in area 4 or other strategic locations in area 4. Because accelerometers 20 are disposed in different locations, accelerometers 20 typically capture vibration data from user taps at slightly different times as a result of the different distances between accelerometers 20 and a surface 6 on which a user 2 taps. Processing system 30 correlates taps from the vibration data of the different accelerometers 20 and identifies the time differences in order to triangulate a location of a user 2 in area 4.

Each accelerometer 20 includes ultra-high sensitivity microfabricated accelerometer technology with three-phase sensing as described by U.S. Pat. Nos. 6,882,019, 7,142,500, and U.S. Pat. No. 7,484,411 and incorporated by reference herein in their entirety. Each accelerometer 20 is a sensor which detects acceleration, i.e., a change in a rate of motion, with a high sensitivity and dynamic range. Because of the three-phase sensing technology, each accelerometer 20 may sense acceleration levels as low as 10's of nano-gravities (ng) and may be manufactured and housed in a device that has typical dimensions of 5×5×0.5 mm or less using Micro-Electro-Mechanical-Systems (MEMS) technology. The combination of high sensitivity and small device size enabled by three-phase sensing techniques allows accelerometers 20 to unobtrusively capture vibration data that includes vibrations tapped by users 2 that represents commands for devices 40 without direct contact between any of accelerometers 20 and users 2. Accelerometers 20 provide vibration data to processing system 30 over any suitable wired or wireless connections (e.g., connections 22 shown in the embodiment of FIG. 5). Additional details of accelerometers 20 are shown and described with reference to FIG. 5 below.

Processing system 30 receives vibration data from each accelerometer 20 over the wired or wireless connections. Processing system 30 includes or otherwise receives or accesses any suitable device configuration information (e.g., device database 166 shown in the embodiment of FIG. 5) that identifies controllable devices 40 in area 4 and the commands that may be performed on each device 40. Processing system 30 registers device information for each device 40 to allow the device 40 to be controlled by processing system 30. The device information defines, explicitly or implicitly, a way of communicating with the device 40 (e.g., using a suitable wired or wireless connection such as a connection 42 shown in the embodiment of FIG. 5) as well as the type and/or format of control signals to provide to devices 40 to cause desired functions to be performed by device 40. The device information also correlates the commands that may be provided by a user 2 and the locations of user 2 with the control signals to allow processing system 30 to determine which control signal to provide to which device 40 upon receiving a command from a user 2 at an identified location in area 4.

Each command recognized by processing system 30 may be any predefined series of taps that a user 2 imparts to a surface 6 in area 4. Each series of taps may be arbitrarily defined by a user 2 (e.g., input by user 2 to processing system 30), selected by user 2 from a database of tap patterns suggested by processing system 30, and/or may follow a signaling convention such as Morse code or other recognizable patterns of signaling.

Processing system 30 is configured to disambiguate commands from a user 2 based on the user's location in area 4. Thus, the same series of taps may be used for controlling one device 40 when user 2 is in one location in area 4 and a different device 40 when user 2 is in another location in area 4. Processing system 30, therefore, may select which device 40 to control based on the location of user 2. The same series of taps may also be defined to simultaneously control multiple devices 40 depending on the location of user 2.

Upon detecting a command for one or more devices 40, processing system 30 generates one or more control signals (e.g., control signals 172 shown in the embodiment of FIG. 5) for the one or more devices 40 and provides the one or more control signals to the one or more devices 40 in area 4. Each device 40 that receives a control signal may respond with an acknowledge signal or other suitable confirmation signal that indicates whether the function corresponding to the control signal was performed successfully. Processing system 30 may store a log of commands that were received as well as a status of the commands (e.g., success or failure) for later review or analysis by a user (e.g., in a command log 168 shown in the embodiment of FIG. 5).

Each device 40 may be any suitable device configured to receive a control signal from processing system 30 and perform a function in response to the control signal. Devices 40 may be in one location in area 4 or distributed at different locations in area 4. One or more devices 40 may also be integrated with processing system 30 (e.g., device 40(3) as shown in the embodiment FIG. 1). Devices 40 communicate with processing system 30 using any suitable wired or wireless connection (e.g., a connection 42 shown in the embodiment of FIG. 5).

In one example shown in FIG. 1, a user 2(1) sitting in a chair in area 4 taps a command onto a surface 6(1) (e.g., the floor) as indicated by an arrow 8(1) to control a device 40(1). Device 40(1) may be a light switch or an electronic device that is near user 2(1), and the command may be to turn on or off device 40(1). Processing system 30 identifies the command and the location of user 2(1) and provides a control signal to device 40(1) based on the command and the location of user 2(1).

In another example, a user 2(2) standing near a wall in area 4 taps a command onto a surface 6(2) (e.g., the wall) as indicated by an arrow 8(2) to control a device 40(2). Device 40(2) may be a thermostat, and the command may be to increase or decrease the temperature in area 4. Processing system 30 identifies the command and the location of user 2(2) and provides a control signal to device 40(2) based on the command and the location of user 2(2).

In a further example, user 2(2) taps a different command onto surface 6(2) as indicated by arrow 8(2) to control a device 40(3). Device 40(3) may be a communications device that notifies authorities of an emergency, and the command may be a request for help. Processing system 30 identifies the command and the location of user 2(2) and provides a control signal to device 40(3) based on the command and the location of user 2(2).

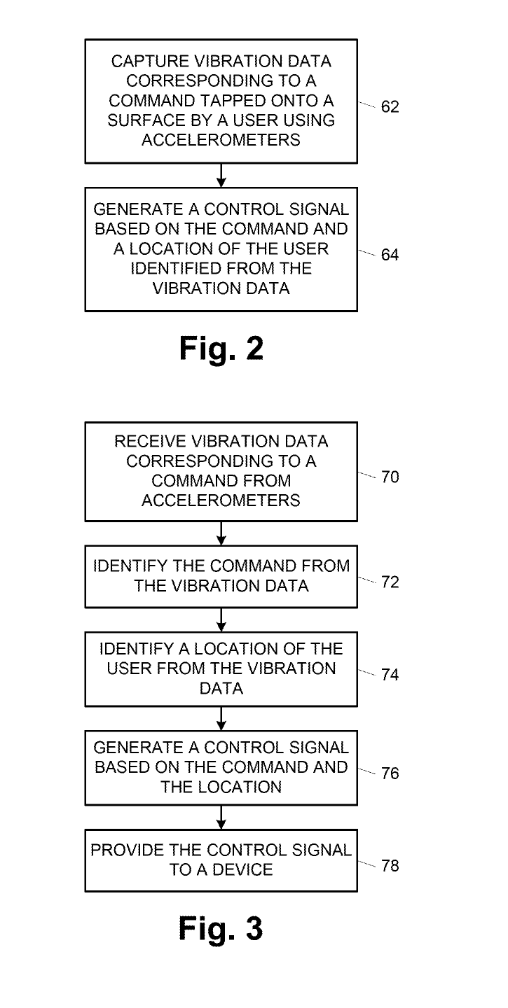

The functions of system 10 are further illustrated in FIG. 2 which is a flow chart illustrating one embodiment of a method for controlling devices 40 based on commands tapped by a user 2. In the embodiment of FIG. 2, accelerometers 20 capture vibration data corresponding to a command tapped by a user 2 as indicated in a block 62. Each accelerometer 20 provides respective vibration data corresponding to the command to processing system 30. Processing system 30 generates a control signal based on the command and a location of user 2 identified from the vibration data as indicated in a block 64. Processing system 30 triangulates the location of user 2 using the respective vibration data from accelerometers 20 and provides the control signal to a device 40 to cause a function corresponding to the control signal to be performed by device 40.

The functions of processing system 30 are further illustrated in FIG. 3 which is a flow chart illustrating one embodiment of a method for processing vibration data to identify a command tapped by a user 2 and a location of user 2. In the embodiment of FIG. 3, processing system 30 receives vibration data corresponding to a command from a user 2 from at least three accelerometers 20 as indicated in a block 70. Processing system 30 identifies the command from the vibration data as indicated in a block 72. Processing system 30 identifies a user location of user 2 from the vibration data using triangulation as indicated in a block 74.

Processing system 30 generates a control signal based on the command and the location as indicated in a block 76. In one embodiment, processing system 30 may generate a first control signal based on the command in response to the user location corresponding to a first predefined location in area 4 or a second control signal based on the command in response to the user location corresponding to a second predefined location in the area that differs from the first predefined location. Processing system 30 provides the control signal to a device as indicated in a block 78. In one embodiment, processing system 30 may provide the control signal to one device 40 in response to the user location corresponding to the first predefined location or to a different device 40 in response to the user location corresponding to the second predefined location. Accordingly, depending on the user location, the control signal may cause a function to be performed on one device 40 if the user is in the first predefined location or the same or a different function to be performed on another device 40 if the user is in the second predefined location.

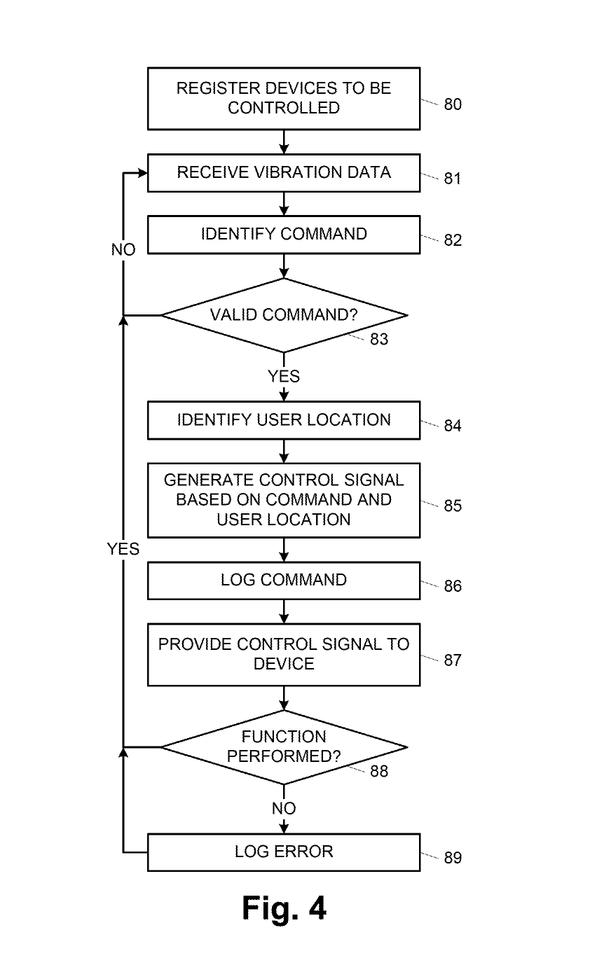

The functions of processing system 30 are further illustrated in FIG. 4 which is a flow chart illustrating one embodiment of a method for controlling devices 40 based on commands tapped by user 2 and a location of user 2. In FIG. 4, processing system 30 registers devices 40 to be controlled as indicated in a block 80. Processing system 30 registers devices 40, in one embodiment, by establishing a connection for communicating, identifying control signals that may be provided to devices 40 to cause functions to be performed, and associating commands and user locations with the control signals. Processing information 30 stores the registration information in device database 166 (shown in FIG. 5) in some embodiments.

Processing system 30 receives vibration data from at least three accelerometers 20 that include a command tapped by a user as indicated in a block 81. Processing system 30 identifies the command as indicated in a block 82 and, if the command is valid, also identifies a user location of the user 2 that tapped the command as indicated in blocks 83 and 84. If the command is not valid, processing system 30 continues receiving vibration data as indicated in block 81.

For valid commands, processing system 30 generates a control signal based on the command and the user location as indicated in a block 85. Processing system 30 also logs the command in as indicated in a block 86. Processing system 30 may log the command in command log 168 (shown in FIG. 5) in some embodiments. Processing system 30 provides the control signal to the device 40 as indicated in a block 87. Processing system 30 determines whether the function corresponding to the control signal was performed by the device 40 as indicated in a block 88. Processing system 30 may make this determination in response to receiving an acknowledge signal from the device 40 in some embodiments. Processing system 30 may omit this block for devices 40 that are not configured to provide an acknowledge signal or other confirmation signal to processing system 30. If the function was performed, processing system 30 continues receiving vibration data as indicated in block 81. If not, processing system 30 logs an error as indicated in a block 89. Processing system 30 may log the error in command log 168 (shown in FIG. 5) in some embodiments.

FIG. 5 is a block diagram illustrating one embodiment 10B of system 10 for controlling devices 40 based on commands tapped by users 2. System 10B includes accelerometers 20(1)-20(M), where M is an integer greater than or equal to three, in communication with processing system 30 across respective connections 22(1)-22(M). System 10B also includes devices 40(1)-40(N), where N is an integer greater than or equal to one, in communication with processing system 30 across respective connections 42(1)-42(N). Processing system 30 receives vibration data 162 from accelerometers 20(1)-20(M) across connections 22(1)-22(M) that includes commands tapped by users and provides control signals 172 to appropriate devices 40(1)-40(N) across connections 42(1)-42(N). Processing system 30 may receive acknowledgement (ACK) signals 182 from any devices 40(1)-40(N) configured to provide signals 182 across connections 42(1)-42(N).

In the discussion below, accelerometer 20 refers to each accelerometer 20(1)-20(M) individually and accelerometers 20 refer to accelerometers 20(1)-20(M) collectively. Connection 22 refers to each connection 22(1)-22(M) individually and connections 22 refer to connections 22(1)-22(M) collectively. Likewise, device 40 refers to each device 40(1)-40(N) individually and devices 40 refer to devices 40(1)-40(N) collectively. Connection 42 refers to each connection 42(1)-42(N) individually and connections 42 refer to connections 42(1)-42(N) collectively.

In the embodiment of FIG. 5, accelerometer 20 includes three layers, or “wafers.” In particular, accelerometer 20 includes a stator wafer 103, a rotor wafer 106, and a cap wafer 109. Stator wafer 103 includes electronics 113 that may be electrically coupled to various electrical components in rotor wafer 106 and cap wafer 109. Also, electronics 113 may provide output ports for coupling to electronic components external to accelerometer 20.

Rotor wafer 106 includes support 116 that is mechanically coupled to a proof mass 119. Although the cross-sectional view of accelerometer 20 is shown, according to one embodiment, support 116 as a portion of rotor wafer 106 surrounds proof mass 119. Consequently, in one embodiment, stator wafer 103, support 116, and cap wafer 109 form a pocket within which proof mass 119 is suspended.

Together, stator wafer 103, support 116, and cap wafer 109 provide a support structure to which proof mass 119 is attached via a compliant coupling. The compliant coupling may, in one embodiment, comprise high aspect ratio flexural suspension elements 123 described in U.S. Pat. No. 6,882,019.

Accelerometer 20 further includes a first electrode array 126 that is disposed on proof mass 119. In one embodiment, first electrode array 126 is located on a surface of proof mass 119 that is opposite the upper surface of stator wafer 103. The surface of the proof mass 119 upon which the first electrode array 126 is disposed is a substantially flat surface.

A second electrode array 129 is disposed on a surface of stator wafer 103 facing opposite first electrode array 126 disposed on proof mass 119. Because proof mass 126 is suspended over stator wafer 103, a substantially uniform gap 133 (denoted by d) is formed between first electrode array 126 and second electrode array 129. The distance d may comprise, for example, anywhere from 1 to 3 micrometers, or it may be another suitable distance.

Proof mass 119 is suspended above stator wafer 103 so that first electrode array 126 and second electrode array 129 substantially fall into planes that are parallel to each other and gap 133 is substantially uniform throughout the overlap between first and second electrode arrays 126 and 129. In other embodiments, electrode arrays 126 and 129 may be placed on other surfaces or structures of stator wafer 103 or proof mass 119.

High aspect ratio flexural suspension elements 123 offer a degree of compliance that allows proof mass 119 to move relative to the support structure of accelerometer 20 (not shown). Due to the design of flexural suspension elements 123, the displacement of proof mass 119 from a rest position is substantially restricted to a direction that is substantially parallel to second electrode array 129, which is disposed on the upper surface of stator wafer 103. Flexural suspension elements 123 are configured to allow for a predefined amount of movement of proof mass 119 in a direction parallel to second electrode array 129 such that gap 133 remains substantially uniform throughout the entire motion to the extent possible. The design of flexural suspension elements 123 provides for a minimum amount of motion of proof mass 119 in a direction orthogonal to second electrode array 129 while allowing a desired amount of motion in the direction parallel to second electrode array 129.

As proof mass 119 moves, capacitances between first and second electrode arrays 126 and 129 vary with the shifting of the arrays with respect to each other. Electronics 113 and/or external electronics are employed to detect or sense the degree of the change in the capacitances between electrode arrays 126 and 129. Based upon the change in the capacitances, such circuitry can generate appropriate signals that are proportional to the vibrations from patient 2 experienced by accelerometer 20.

The operation of accelerometer 20 is enhanced by the use of three-phase sensing and actuation as described by U.S. Pat. No. 6,882,019 and U.S. Pat. No. 7,484,411. Three-phase sensing uses an arrangement of sensing electrodes 126 and 129 and sensing electronics 113 to enhance the output signal of accelerometer 20 and allow for the sensitivity to be maximized in a desired range. It also allows the output of accelerometer 20 to be “reset” to zero electronically when the sensor is in any arbitrary orientation.

Processing system 30 represents any suitable processing device, or portion of a processing device, configured to implement the functions of the method shown in FIG. 5 and described above. A processing device may be a laptop computer, a tablet computer, a desktop computer, a server, or another suitable type of computer system. A processing device may also be a mobile telephone with processing capabilities (i.e., a smart phone) or another suitable type of electronic device with processing capabilities. Processing capabilities refer to the ability of a device to execute instructions stored in a memory 144 with at least one processor 142. Processing system 30 represents one of a plurality of processing systems in a cloud computing environment in one embodiment.

Processing system 30 includes at least one processor 142 configured to execute machine readable instructions stored in a memory system 144. Processing system 30 may execute a basic input output system (BIOS), firmware, an operating system, a runtime execution environment, and/or other services and/or applications stored in memory 144 (not shown) that includes machine readable instructions that are executable by processors 142 to manage the components of processing system 30 and provide a set of functions that allow other programs to access and use the components. Processing system 30 stores vibration data 162 received from accelerometers 20 in memory system 144 along with a command unit 164 that identifies commands from vibration data 162 and user locations from vibration data 162, generates control signals 172 based on the commands and user locations, and provides control signals 172 to devices 40 as described above with reference to FIGS. 1-4. Processing system 30 further stores device database 166 and command log 168 in some embodiments.

Processing system 30 may also include any suitable number of input/output devices 146, display devices 148, ports 150, and/or network devices 152. Processors 142, memory system 144, input/output devices 146, display devices 148, ports 150, and network devices 152 communicate using a set of interconnections 154 that includes any suitable type, number, and/or configuration of controllers, buses, interfaces, and/or other wired or wireless connections. Components of processing system 30 (for example, processors 142, memory system 144, input/output devices 146, display devices 148, ports 150, network devices 152, and interconnections 154) may be contained in a common housing with accelerometer 20 (not shown) or in any suitable number of separate housings separate from accelerometer 20 (not shown).

Each processor 142 is configured to access and execute instructions stored in memory system 144 including command unit 164. Each processor 142 may execute the instructions in conjunction with or in response to information received from input/output devices 146, display devices 148, ports 150, and/or network devices 152. Each processor 142 is also configured to access and store data, including vibration data 162, device database 166, and command log 168, in memory system 144.

Memory system 144 includes any suitable type, number, and configuration of volatile or non-volatile storage devices configured to store instructions and data. The storage devices of memory system 144 represent computer readable storage media that store computer-readable and computer-executable instructions including command unit 164. Memory system 144 stores instructions and data received from processors 142, input/output devices 146, display devices 148, ports 150, and network devices 152. Memory system 144 provides stored instructions and data to processors 142, input/output devices 146, display devices 148, ports 150, and network devices 152. Examples of storage devices in memory system 144 include hard disk drives, random access memory (RAM), read only memory (ROM), flash memory drives and cards, and other suitable types of magnetic and/or optical disks.

Input/output devices 146 include any suitable type, number, and configuration of input/output devices configured to input instructions and/or data from a user to processing system 30 and output instructions and/or data from processing system 30 to the user. Examples of input/output devices 146 include a touchscreen, buttons, dials, knobs, switches, a keyboard, a mouse, and a touchpad.

Display devices 148 include any suitable type, number, and configuration of display devices configured to output image, textual, and/or graphical information to a user of processing system 30. Examples of display devices 148 include a display screen, a monitor, and a projector. Ports 150 include suitable type, number, and configuration of ports configured to input instructions and/or data from another device (not shown) to processing system 30 and output instructions and/or data from processing system 30 to another device.

Network devices 152 include any suitable type, number, and/or configuration of network devices configured to allow processing system 30 to communicate across one or more wired or wireless networks (not shown). Network devices 152 may operate according to any suitable networking protocol and/or configuration to allow information to be transmitted by processing system 30 to a network or received by processing system 152 from a network.

Connection 22 includes any suitable type and combination of wired and/or wireless connections that allow accelerometer 20 to provide vibration data 162 to processing system 30. Connection 22 may connect to one or more ports and/or one or more network devices 152 of processing system 30. For example, connection 22 may comprise a wireless network connection that includes a wireless network device (not shown) that transmits vibration data 162 from accelerometer 20 to processing system 30. As another example, connection 22 may comprise a cable connected from accelerometer 20 to a port 150 to transmit vibration data 162 from accelerometer 20 to processing system 30.

Connection 42 includes any suitable type and combination of wired and/or wireless connections that allow device 40 to receive control signals 172 from processing system 30 and provide acknowledgement signals 182 from device 40 to processing system 30. Connection 42 may connect to one or more ports and/or one or more network devices 152 of processing system 30. For example, connection 42 may comprise a wireless network connection that includes a wireless network device (not shown) that receives control signals 172 from processing system 30 and transmits acknowledgement signals 182 from device 40 to processing system 30. As another example, connection 42 may comprise a cable connected from device 40 to a port 150 to receives control signals 172 from processing system 30 and transmits acknowledgement signals 182 from device 40 to processing system 30.

The above embodiments may advantageously provide a user with the ability to control devices with using no remote controls or devices that are carried with the user.

What is claimed is:

1. A system comprising:
at least three accelerometers disposed in different locations of an area to capture respective vibration data corresponding to a command tapped onto the surface by a user, the area including a surface; and
a processing system to receive the vibration data from each accelerometer, identify the command and a location of the user from the vibration data, and generate a control signal based on the command and the location.

2. The system of claim 1 wherein the processing system is to provide the control signal to a device in the area.

3. The system of claim 2 wherein the processing system is to select the device for receiving the control signal based on the location of the user.

4. The system of claim 2 wherein the processing system is to register the device and the command prior to receiving the vibration data.

5. The system of claim 2 wherein the processing system is to receive an acknowledge signal from the device in response to the control signal.

6. The system of claim 1 wherein the processing system is to identify the location of the user using triangulation.

7. The system of claim 1 wherein the accelerometers each include a proof mass with a first electrode array suspended above a second electrode array disposed on a wafer.

8. The system of claim 1 wherein the accelerometers each include three-phase sensing and actuation.

9. The system of claim 1 wherein the accelerometers each detect changes in capacitances between a first electrode arrays disposed on a proof mass and a second electrode array disposed on a wafer.

10. A method performed by a processing system, the method comprising:
receiving vibration data captured by at least three accelerometers disposed in different locations of an area in response to a user tapping a command on a surface in the area;
processing the vibration data with the processing system to identify the command and a user location;
generating a first control signal based on the command in response to the user location corresponding to a first predefined location in the area; and
generating a second control signal based on the command in response to the user location corresponding to a second predefined location in the area that differs from the first predefined location.

11. The method of claim 10 further comprising:
providing the first control signal to a first device in response to the user location corresponding to the first predefined location; and
providing the second control signal to a second device in response to the user location corresponding to the second predefined location.

12. The method of claim 10 wherein the first control signal causes a first function to be performed on a device, and wherein the second control signal causes a second function to be performed on the device.

13. The method of claim 10 further comprising:
identifying the user location by triangulating the vibration data.

14. A computer-readable storage medium storing instructions that, when executed by a processing system, perform a method comprising:
receiving first vibration data captured by at least three accelerometers disposed in different locations of an area in response to a user tapping a first command on a first surface in the area; and
generating a first control signal to cause a first function to be performed based on the first command and a first user location determined from the first vibration data.

15. The computer-readable storage medium of claim 14, the method further comprising:
receiving second vibration data captured by the at least three accelerometers while the user tapped a second command on a second surface in the area; and
generating a second control signal to cause a second function to be performed based on the second command and a second user location determined from the second vibration data, the second user location differing from the first user location.
